(19) United States
(12) Patent Application Publication
(10) Pub. No.: US 2011/0187059 A1
(43) Pub. Date: Aug. 4, 2011

(54) Sealing Gasket for Corrugated Pipe

(75) Inventors: Randall Chinchilla, San Jose, CA (US); Marco Castro, San Jose, CA (US)

(73) Assignee: S & B Technical Products, Inc., Fort Worth, TX (US)

(21) Appl. No.: 12/776,776

(22) Filed: May 10, 2010

Related U.S. Application Data
(60) Provisional application No. 61/301,296, filed on Feb. 4, 2010.

(51) Int. Cl. F16L 21/035; F16J 15/06

(52) U.S. Cl. 277/625; 277/626

(57) ABSTRACT

A sealing gasket and pipe coupling system for corrugated pipe where a male pipe end of a male section of corrugated pipe has an axially extending bore defined by a smooth inner wall fused to a corrugated outer wall having axially adjacent, annular, outwardly-extending corrugation ribs separated by corrugation valleys, each corrugation rib having a circumference. The sealing gasket has an annular gasket body with an inner circumferential region which defines a base for the gasket and an outer sealing region, the inner circumferential region of the gasket is received within a selected corrugation valley of the male pipe end. The base of the gasket body includes a pair of laterally extending lips which, when viewed in cross section, extend outwardly across the selected corrugation valley to fit larger valleys and which bend inwardly to fit narrower valleys. The base of the gasket body extends radially outward to form a main body region, the main body region having a pair of oppositely arranged wing portions which are separated from the laterally extending lips by void regions which accommodate inward bending of the lateral lips in narrower valleys.

### CROSS-REFERENCE TO RELATED APPLICATIONS

The present application claims priority from earlier filed provisional application Ser. No. 61/301,296, filed Feb. 4, 2010, entitled “Sealing Gasket for Corrugated Pipe,” by Randall Chinchilla and Marco Castro.

### BACKGROUND OF THE INVENTION

1. Field of the Invention

The present invention relates generally to the field of plastic pipe joints or connections, and in particular, to an improved sealing gasket for use in joining double wall corrugated plastic pipe.

2. Description of the Related Art

Pipes formed from thermoplastic materials including polyolefins such as polyethylene and PVC are used in a variety of industries. For example, pipes are commonly used in the municipal waterworks industry for the conveyance of fluids such as water and sewage. It is well known in the art to extrude plastic pipes of this type in an elongated cylindrical configuration of a desired diameter and to then cut the extruded product into individual lengths of convenient size suitable for handling, shipping and installing. Each length of pipe is enlarged or “belled” at one end sufficiently to join or connect with the next adjacent pipe section by inserting an unenlarged or “spigot” male end of the next adjacent length of pipe into the enlarged bell pipe end. The inside diameter of the bell is formed sufficiently large to receive the spigot end in telescoping fashion.

In addition to “straight” runs of PVC pipe, corrugated plastic pipe is also sometimes used in the waterworks industry, such as in watertight gravity-flow drainage and sewage applications. By “corrugated pipe” is meant a length of plastic pipe of the type having a smooth inner cylindrical liner or sidewall connected to an outer corrugated sidewall defined by alternating annular rib and valley portions. Such pipe is well known in the waterworks industry and is commercially available from a number of sources. As with straight wall PVC pipe, some form of sealing element or composition must be used to form a secure connection between the male and female pipe ends. In the case of straight PVC pipe, an annular elastomeric ring or gasket is typically installed between the exterior of the male or spigot pipe end and the female bell pipe end being joined. As the spigot is inserted within the female pipe end, the gasket performs a major sealing function and provides the major seal capacity for the joint.

Corrugated plastic pipe requires that a sealing element to be installed between the corrugations on the exterior of the spigot pipe end and the interior surface of the female pipe end being joined in order to implement a socket-spigot type pipe joint. In the past, this sealing element was typically extruded, vulcanized into a closed ring, and then stretched over the spigot pipe end so that the sealing element was installed a the valley between two of the ribs or corrugations in the valley or raceway formed on the spigot end. While this type of joint has been used for many years in the industry, certain problems continue to exist. For example, the width of the valley, or raceway, between corrugations has relatively high tolerances. Furthermore, different manufacturing plants produce product with significant differences in raceway width. The sealing gasket for corrugated pipe must therefore by especially forgiving to accept these differences in tolerances and manufacture.

There thus continues to be a need for an improved sealing element for corrugated pipe of the type described above which will adapt to these variations, remain in the intended position, and provide effective sealing under even demanding conditions.

### SUMMARY OF THE INVENTION

In accordance with the present invention, an improved coupling system and sealing gasket are provided for joining corrugated plastic pipe which system accommodates the variations in raceway dimensions present in various manufacturer's pipe and which also effectively improves the coupling's sealing capability. The sealing gasket which is used in practicing the invention is particularly well suited for use in gravity-flow drainage and sewage applications requiring watertight joints and involving the use corrugated plastic pipe of the type having a smooth inner cylindrical sidewall connected to an outer corrugated sidewall defined by alternating annular rib and valley portions. The improved sealing gasket forms a part of a coupling system in which the spigot end of one section of corrugated pipe which is received within a bell end of an adjoining section of pipe which terminates in a gasket bed formed in a raceway between two adjoining raised ribs. The raceway forms an annular gasket bed which opens outwardly and retains an elastomeric gasket of the invention therein.

The improved gasket of the invention is seated and retained within the gasket bed or raceway and is constructed of sufficient volume to substantially fill the gasket chamber formed by the gasket bed while also protruding outwardly beyond the outer confines of the bed-forming ribs on either side. Under such conditions, upon perfecting the coupled joint, the gasket will bear against the interior sealing surface of the female pipe end and be compressed between the male and female pipe ends, resulting in compression of the gasket in both the radial and axial directions. Preferably, the gasket is constructed of sufficient volume such that, when compressed, it will tend to flow partly over the raised rib portions present on either side of the gasket bed.

In its preferred form, the sealing gasket of the invention is intended to be used with a male pipe end of a male section of corrugated pipe having an axially extending bore defined by a smooth inner wall fused to a corrugated outer wall having axially adjacent, annular, outwardly-extending corrugation ribs separated by corrugation valleys, each corrugation rib having a circumference. The sealing gasket of the invention has an annular gasket body having an inner circumferential region which defines a base for the gasket and an outer sealing region, the inner circumferential region of the gasket being received within a selected corrugation valley of the male pipe end. The base of the gasket body includes a pair of laterally extending lips which, when viewed in cross section, extend outwardly across the selected corrugation valley to fit larger valleys and which bend inwardly to fit narrower valleys. The base of the gasket body extends radially outward to form a main body region, the main body region having a pair of oppositely arranged wing portions which are separated from the laterally extending lips by void regions which accommodate inward bending of the lateral lips in narrower valleys. The main body region of the gasket body continues radially outward from the wing portions to form the outer sealing region of the gasket body.

Preferably, each of the oppositely arranged wing portions extends outwardly across one corrugation valley and between two adjacent corrugation ribs. Also, the inner circumferential region at the base of the gasket body includes a void region which increases flexibility of the gasket and which promotes contact stress concentration for improved sealing characteristics of the gasket. In one form, the outer sealing region of the gasket body is an apex shaped protrusion which extends radially outward from the main body portion and the oppositely arranged wing portions of the gasket.

The improved sealing gasket of the invention is part of a coupling system for joining corrugated pipe of the type described. The coupling includes a section of pipe having a spigot end and an outer corrugated sidewall defined by spaced apart successive annular ribs with annular valley-defining portions disposed there between. A gasket bed is formed by the outer sidewall adjacent the spigot end of the section of pipe, the gasket bed being defined by and disposed between an annular rib wall and an adjoining terminal annular bed-forming rib located at the spigot end of the section of pipe. A sealing gasket of the invention, as previously described, is seated within the gasket bed and protrudes outwardly therefrom beyond outer confines of the bed-forming rib. The coupling system includes a bell pipe end of an adjoining section of pipe which receives the spigot pipe end and its associated sealing gasket.

Additional objects, features and advantages will be apparent in the written description which follows.

### BRIEF DESCRIPTION OF THE DRAWINGS

FIG. 1 is a perspective view, partly broken away, of male and female corrugated pipe sections about to be made up into a pipe coupling.

FIG. 2 is a side, cross sectional view of the improved sealing gasket of the invention in place on the exterior surface of the male pipe end of the pipe section shown in FIG. 1.

FIG. 3 is a side cross sectional view similar to FIG. 2 but showing the initial stage of the make up of the pipe coupling in which the male pipe end is received within the female pipe end of the pipes shown in FIG. 1.

FIG. 4 is a view similar to FIG. 3, but showing the fully made up pipe coupling featuring the improved sealing element of the invention.

### DETAILED DESCRIPTION OF THE PREFERRED EMBODIMENT

The present invention will be described particularly with respect to corrugated double wall plastic pipe. However, as will be evident from the discussion which follows, it will be appreciated that the principles of the present invention may also find application in other types of pipe and tubing configurations where watertight joints are deemed desirable.

In the discussion which follows, the terms “female pipe end,” “socket end,” and “bell end” will sometimes be used interchangeably and will be understood to mean the enlarged pipe end having an end opening of sufficient diameter to receive the mating male or “spigot pipe end” in telescoping fashion in order to form a pipe joint.

Under current standards established by the American Society of Testing and Materials (ASTM), it is required that corrugated polyethylene pipe intended for use in certain drain and gravity sewage applications achieve a watertight joint to a pressure of approximately 10.8 psi during laboratory testing. In attempting to meet these standards, manufacturers of corrugated polyethylene pipe have traditionally utilized a bell and spigot joint design, whereby a gasket is compressed radially between the outside diameter (OD) of the spigot and the internal diameter (ID) of the bell. These types of designs have been widely utilized and are disclosed in a number of different patents (e.g. U.S. Pat. Nos. 5,687,976; 6,343,623; and 5,992,469, to name a few).

Although the traditional bell and spigot design with a radially compressed gasket has worked well and has provided an adequate seal in a number of applications, several factors can affect the integrity of the sealing action. First, if the gasket is designed such that there is insufficient restraint to hold the radially compressed gasket in place in use, the lateral or axial force exerted on such gasket due to hydrostatic pressure can cause the gasket to slip or “blow out,” thereby causing leakage between the spigot and bell. With a radially compressed gasket, such restraint is at least partly frictional by nature, due to the inherent properties of the gasket material. However, in order to facilitate joint assembly, it is often necessary to apply a lubricant to the gasket, which lowers its coefficient of friction, thus exasperating the problem of slippage with certain of the prior art designs.

One way to minimize this potential for gasket slippage, therefore, is to design the pipe joint to have as small a clearance between the bell and the spigot as possible. This minimizes the force on the gasket when the joint is pressurized, but, from a manufacturing standpoint, can be difficult to hold the tight tolerances required. Also, while closer tolerances mean better sealing, it does lead to more difficult installation, due to the fiction between the gasket and the bell.

Another issue with the current bell and spigot design utilizing a radially compressed gasket is that the internal water pressure in the joint system causes the bell to expand at the point of intersection with the gasket, presenting the possibility of leakage. The bell has to be sufficiently stiff to restrain this force, and with larger pipe sizes it may be difficult to manufacture a bell with enough stiffness to achieve these objectives.

It is evident then that the current coupling systems used for corrugated plastic pipe in watertight gravity-flow drainage and sewage applications have certain design limitations which may make them prone to leakage problems when subjected to increasing internal and external hydrostatic pressures. The present invention, therefore, has as a primary object to provide a new and improved coupling system with a newly designed sealing gasket which will eliminate or significantly reduce the above-mention problems, and others, of the current joint designs.

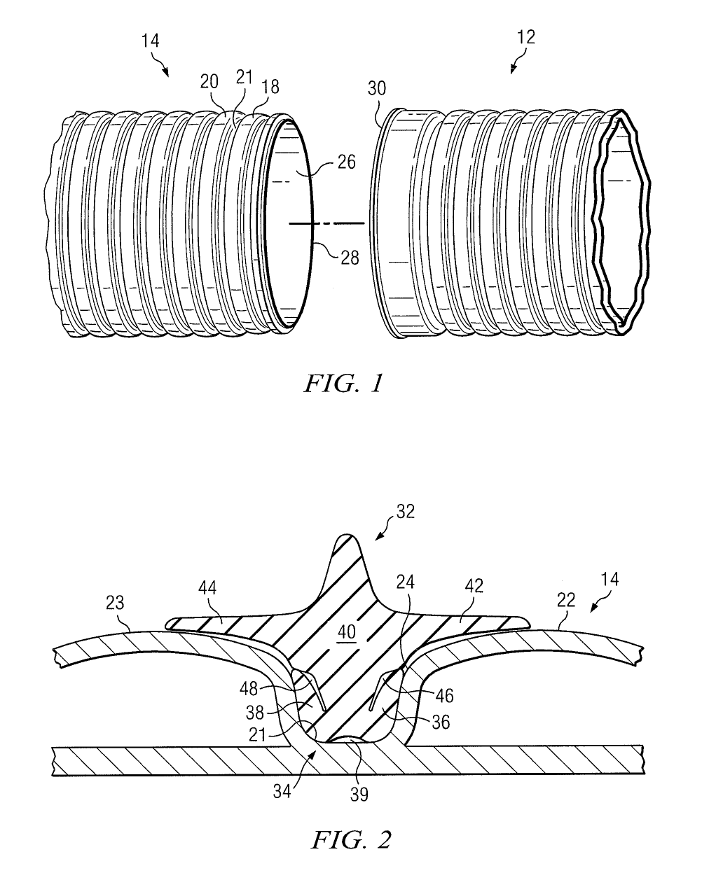

With reference now to FIG. 1 of the drawings, an improved bell and spigot coupling system is shown which is particularly well-suited for use in joining sections of corrugated plastic pipe 12, 14 in gravity flow drainage and sewage applications requiring watertight joints. In accordance with the present invention, the adjoining sections of pipe 12, 14 each have an outer corrugated sidewall defined by spaced apart successive annular ribs 18, 20 with annular valley defining portions 21 deposed there between. Each successive rib 18, 20 (see FIG. 2) is formed having a rib crest 22, 23 and annular rib walls 24 which extend radially inward from the crest 22 to interconnect with and define the adjacent valley defining portions 21 of the sidewall 24. As can be best seen in FIG. 2, the corrugated pipe section 14 is of the dual wall type having an inner cylindrical smooth sidewall or liner 26 that is attached to and integrally formed with the outer corrugated sidewall at each of the valley defining portions 21 thereof.

As illustrated in FIGS. 1 and 2, each section of corrugated pipe has a male end portion 14 with a terminal spigot end 28, and an opposite female end portion or bell end 30 which is constructed and adapted to receive the spigot end 28 of a similarly constructed section of pipe 14 to complete the pipe joint. While the drawings herein disclose a single coupling system using the sealing gasket of the invention for joining sections of pipe 12, 14 it will be appreciated that multiple sections of pipe can be joined together in like manner to form a corrugated piping system of indeterminate length.

With reference again to FIG. 2, it can be seen that the male end portion 14 of the corrugated pipe which is received within bell 12 includes the pair of annular ribs 22 and 23. The adjacent rib crests, such as crest 22, together with the annular rib walls 24 which extend radially inward from the crest 22 define a gasket bed within which an annular elastomeric gasket (32 in FIG. 2) is retained. As will be appreciated from FIGS. 1 and 2, the bell pipe end 12 includes a generally cylindrical interior sidewall, such as sidewall 26 of the male pipe end, the inside diameter of which is just slightly greater than the outside diameter of the male end portion 28 of the section of pipe 14 received therein. The cylindrical interior sidewall of the bell pipe end forms a gasket sealing surface which follows the general contour of the inserted pipe's spigot end 28, and interfaces therewith to define a gasket chamber which houses gasket 32.

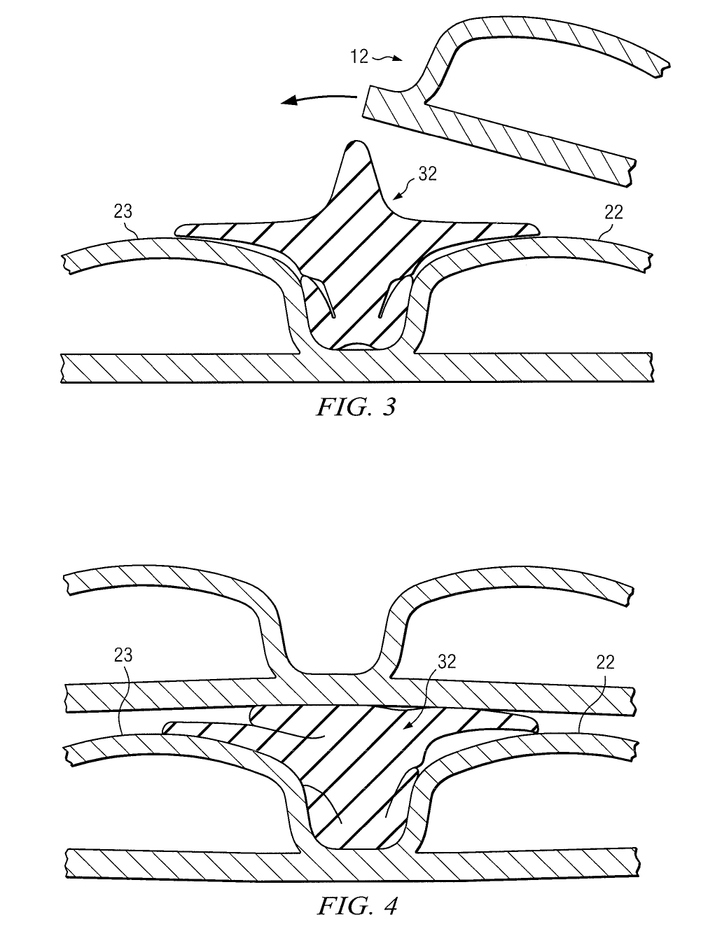

As further shown in FIG. 2, the elastomeric gasket 32 which is seated and retained within the previously described gasket bed is constructed of sufficient volume to substantially fill the resulting gasket chamber and protrude outwardly beyond the outer confines of the bed-forming ribs 22, 23. Under such circumstances, and upon the make up of the coupled joint, the gasket 32 will be compressed within the gasket bed and between the adjacent ribs 22, 23. As seen in FIGS. 3 and 4, the gasket is preferably constructed of sufficient volume such that, when compressed, it will tend to flow over the adjacent rib crests to some extent.

One dimensional example for a corrugated pipe of the type under consideration will now be described. For an eighteen inch corrugated pipe, an exemplary embodiment would include an inner wall or liner having a thickness of about 0.052 inches and an outer wall having a thickness of about 0.08 inches to about 0.09 inches. The thickness of the walls may not be completely uniform. The distance between the midpoint of adjacent corrugation valleys is about 2.600 inches. The distance between the top of the thickness that forms the corrugation valley 21 and the top of the thickness that forms the corrugation crest 22 is about 1.35 inches. The thickness of the outer layer may not be completely uniform.

With reference again now to FIG. 2 of the drawings, the coupling system of the invention features a novel sealing gasket or element 32, as has been briefly described. The annular gasket body has an inner circumferential region which defines a base 34 for the gasket and an outer sealing region, the inner circumferential region of the gasket being received within a selected corrugation valley 21 of the male pipe end 14. As will be appreciated from FIG. 2, the base 34 of the gasket body includes a pair of laterally extending lips 36, 38, which when viewed in cross section, extend outwardly across the selected corrugation valley 21 to fit larger valleys and which bend inwardly to fit narrower valleys, depending upon the manufacturing tolerances of the particular pipe employed. The base also includes a void region 39 which increases flexibility of the gasket and which promotes contact stress concentration for improved sealing characteristics of the gasket.

The base 34 of the gasket extends radially outward to form a main body region 40. The main body region 40 has a pair of oppositely arranged wing portions 42, 44, which are separated from the laterally extending lips 36, 38, by void regions 46, 48, which accommodate inward bending of the lateral lips in narrower pipe valleys. Each of the oppositely arranged wing portions 42, 44, extends outwardly in a lateral direction across one corrugation valley 21 and between two adjacent corrugation ribs, e.g., ribs 22, 23, in FIG. 2.

The main body region 40 of the gasket body continues radially outward from the wing portions 42, 44, to form the outer sealing region of the gasket body. In the particular embodiment of the sealing gasket shown in FIG. 2, the outer sealing region is a generally apex shaped protrusion from the main body region 40. However, it will be appreciated by those skilled in the relevant arts that the outer sealing region of the gasket body could assume different shapes, depending upon the particular manufacture of pipe employed or the particular conditions of use.

The sealing gasket of the invention is thus used as a part of a coupling system for corrugated pipe, made up of:

a section of pipe having a spigot end and an outer corrugated sidewall defined by spaced apart successive annular ribs with annular valley-defining portions disposed there between;

a gasket bed formed by the outer sidewall adjacent the spigot end of the section of pipe, the gasket bed being defined by and disposed between an annular rib wall and an adjoining terminal annular bed-forming rib located at the spigot end of the section of pipe;

a sealing gasket seated within the gasket bed and protruding outwardly therefrom beyond outer confines of the bed-forming rib;

wherein the sealing gasket comprises an annular gasket body having an inner circumferential region which defines a base for the gasket and an outer sealing region, the inner circumferential region of the gasket being received within a selected corrugation valley of the male pipe end;

wherein the base of the gasket body includes a pair of laterally extending lips which, when viewed in cross section, extend outwardly across the selected corrugation valley to fit larger valleys and which bend inwardly to fit narrower valleys;

wherein the base of the gasket body extends radially outward to form a main body region, the main body region having a pair of oppositely arranged wing portions which are separated from the laterally extending lips by void regions which accommodate inward bending of the lateral lips in narrower valleys;

wherein the main body region of the gasket body continues radially outward from the wing portions to form the outer sealing region of the gasket body.

FIGS. 3 and 4 illustrate the successive steps in the make up of a joint of corrugated pipe. In FIG. 3, the initial stage of the assembly is illustrated. The male, spigot pipe end 14 is just beginning to be received within the female, bell pipe end 12. FIG. 4 illustrates the fully made up position of the joint and shows the gasket being deformed within the raceway and between the adjacent corrugation ribs of the male pipe end.

An invention has been provided with several advantages. The improved sealing gasket of the invention can be used in a coupling system for corrugated pipe which better accommodates variations in tolerances of pipe manufacture where pipe is supplied from various suppliers. The gasket makes better sealing contact even where the width of the valley between the corrugations has a relatively high manufacturing tolerance. The design makes better allowance for the fact that different manufacturing plants show significant differences in raceway width. The sealing gasket of the invention will adapt to these variations in manufacture and remain in place in proper position for sealing under even adverse conditions.

While the invention has been shown in only one of its forms, it is not thus limited but is susceptible to various changes and modifications without departing from the spirit thereof.

What is claimed is:

1. A sealing gasket for a male pipe end of a male section of corrugated pipe having an axially extending bore defined by a smooth inner wall fused to a corrugated outer wall having axially adjacent, annular, outwardly-extending corrugation ribs separated by corrugation valleys, each corrugation rib having a circumference, the sealing gasket comprising:
an annular gasket body having an inner circumferential region which defines a base for the gasket and an outer sealing region, the inner circumferential region of the gasket being received within a selected corrugation valley of the male pipe end;
wherein the base of the gasket body includes a pair of laterally extending lips which, when viewed in cross section, extend outwardly across the selected corrugation valley to fit larger valleys and which bend inwardly to fit narrower valleys;
wherein the base of the gasket body extends radially outward to form a main body region, the main body region having a pair of oppositely arranged wing portions which are separated from the laterally extending lips by void regions which accommodate inward bending of the lateral lips in narrower valleys;
wherein the main body region of the gasket body continues radially outward from the wing portions to form the outer sealing region of the gasket body.

2. The sealing gasket of claim 1, wherein each of the oppositely arranged wing portions extends outwardly across one corrugation valley and between two adjacent corrugation ribs.

3. The sealing gasket of claim 2, wherein the inner circumferential region at the base of the gasket body includes a void region which increases flexibility of the gasket and which promotes contact stress concentration for improved sealing characteristics of the gasket.

4. The sealing gasket of claim 3, wherein the outer sealing region of the gasket body is an apex shaped protrusion which extends radially outward from the main body portion and the oppositely arranged wing portions of the gasket.

5. A coupling system for corrugated pipe, comprising:
a section of pipe having a spigot end and an outer corrugated sidewall defined by spaced apart successive annular ribs with annular valley-defining portions disposed therebetween;
a gasket bed formed by the outer sidewall adjacent the spigot end of the section of pipe, the gasket bed being defined by and disposed between an annular rib wall and an adjoining terminal annular bed-forming rib located at the spigot end of the section of pipe;
a sealing gasket seated within the gasket bed and protruding outwardly therefrom beyond outer confines of the bed-forming rib;
wherein the sealing gasket comprises an annular gasket body having an inner circumferential region which defines a base for the gasket and an outer sealing region, the inner circumferential region of the gasket being received within a selected corrugation valley of the male pipe end;
wherein the base of the gasket body includes a pair of laterally extending lips which, when viewed in cross section, extend outwardly across the selected corrugation valley to fit larger valleys and which bend inwardly to fit narrower valleys;
wherein the base of the gasket body extends radially outward to form a main body region, the main body region having a pair of oppositely arranged wing portions which are separated from the laterally extending lips by void regions which accommodate inward bending of the lateral lips in narrower valleys;
wherein the main body region of the gasket body continues radially outward from the wing portions to form the outer sealing region of the gasket body.

6. The sealing gasket of claim 5, wherein each of the oppositely arranged wing portions extends outwardly across one corrugation valley and between two adjacent corrugation ribs.

7. The sealing gasket of claim 6, wherein the inner circumferential region at the base of the gasket body includes a void region which increases flexibility of the gasket and which promotes contact stress concentration for improved sealing characteristics of the gasket.

8. The sealing gasket of claim 7, wherein the outer sealing region of the gasket body is an apex shaped protrusion which extends radially outward from the main body portion and the oppositely arranged wing portions of the gasket.

9. The coupling system of claim 8, wherein the coupling includes a bell pipe end of an adjoining section of pipe which receives the spigot pipe end, the spigot pipe end terminating in a gasket bed formed in a raceway between two adjoining raised ribs.

10. The coupling system of claim 9, wherein the gasket bed opens outwardly and retains a sealing gasket of the invention.
